(19) United States
(12) Patent Application Publication
(10) Pub. No.: US 2010/0011422 A1
(43) Pub. Date: Jan. 14, 2010

(54) PORTABLE ACCOUNT INFORMATION

(75) Inventors: Duncan Fraser Mason, Glasgow (GB); Neil David Grant, Dumbarton (GB)

Correspondence Address: NIXON & VANDERHYE, PC, 901 NORTH GLEBE ROAD, 11TH FLOOR, ARLINGTON, VA, 22203, US

(73) Assignee: WEE-WORLD LIMITED, GLASGOW (GB)

(21) Appl. No.: 12/279,643

(22) PCT Filed: Feb. 16, 2007
(86) PCT No.: PCT/GB07/00556

§ 371 Date: Dec. 29, 2008

Related U.S. Application Data
(60) Provisional application No. 60/773,688, filed on Feb. 16, 2006.

(51) Int. Cl. G06F 21/20

(52) U.S. Cl. 726/5

(57) ABSTRACT

A method of providing portable account information includes associating two accounts (10, 11) and retrieving the details of one account (15) using the identifier of the other. An embodiment of the invention provides management of the association between a user's avatar account 10 and various client applications (11), e.g. for instant messaging or community websites. In addition to management of this association, the invention also handles the diverse login and authentication (12) needs of avatar accounts and the various supported client applications. Rather than have a different avatar for each application, the invention allows the user to have a single avatar account which they can associate (13) with each of the client applications that they use to render (16) and update (17) the avatar. Thus, the user can travel between client applications (11) with a portable digital identity.

The present invention relates to the management of user accounts, in particular the portability of information between accounts.

In the field of using computer applications, authentication of access to applications is commonly provided by users having account identifiers and also typically passwords. The Internet and World Wide Web provide users with a convenient way to quickly and easily navigate and switch from one application to another, e.g., MSN™ Messenger™, Skype™, Friends Reunited™, etc. The user can log into each application and configure their account information within that application. This account information may be personal information related to the user or their account. One particular class of personal information includes the attributes that describe what the user looks like or has interest in. An avatar provides a convenient way to display this information. Also an interactive avatar builder, such as disclosed in International Application WO 2004/023336, provides a convenient technology for capturing such attributes for storing in a database such that the attributes can be subsequently retrieved for rendering an avatar or some other purpose.

However, there is a problem for users in having different accounts in that the account information is not easily shared between accounts, for example the user may create a different avatar for each application.

A unified log in, such as Microsoft™ Passport™ allows users to have just one account identifier and password to log into a variety of different applications. However, this approach can compromise the security of the authentication of each application. It is more secure to have different account identifiers for each separate application.

It is an object of the present invention to provide improved portability of account information between applications.

According to the first aspect of the present invention, there is provided a method of retrieving user account information comprising the steps of:
providing a first user account having a first account identifier and first account information;
providing a second user account having a second account identifier;
associating the second account identifier with the first user account; and
retrieving the first account information using the associated second account identifier.

Optionally, the step of providing a second user account is performed prior to the step of providing a first user account.

Preferably, the method further comprises the step of authenticating the second account identifier prior to the step of retrieving the first account information.

Preferably, the method further comprises the step of authenticating the first user account prior to the step of associating the second account with the first user account.

Preferably, the method further comprises the step of authenticating the second user account prior to the step of associating the second account identifier with the first user account.

Preferably, the step of providing a first user account comprises the steps of:
providing access to a first user account application;
receiving the first account information into the first user account application; and
creating the first user account.

Optionally, the access to the first user account application is provided, subsequent to authenticating the second user account, directly from a second user account application.

Preferably, the step of authenticating the second user account comprises the steps of logging in to the second user account application and passing the second account identifier to the first user account application.

Preferably, the step of creating the first user account comprises building an avatar and saving the avatar profile.

Preferably, the step of associating comprises storing the second account identifier in an association table.

Preferably, the step of associating comprises storing the second account identifier in an account profile of the first user account.

Preferably, the step of associating comprises a user choosing a second account provider prior to the step of logging in to the second user account application.

Preferably, the first account information comprises personal information relating to a user.

Preferably, the first account information comprises attributes of the user.

Preferably, the first account information comprises historical account information.

Preferably, the historical account information comprises a history of changes.

Preferably, the method further comprises the step of rendering an avatar using the first account information.

Preferably, the method further comprises the step of rendering an asset associated with the avatar using the first account information.

Preferably, the asset comprises a background.

Preferably, the asset comprises an object.

Preferably, the step of rendering is performed by an application the use of which has been authenticated by the step of authenticating the second account identifier.

Preferably, the method further comprises the steps of:
the first user account application passing to the second user account application a link to resources for rendering the avatar; and
the second user account application rendering the avatar using the linked resources.

According to a second aspect of the present invention there is provided at least one computer program comprising program instructions for causing at least one computer to perform the method according to the first aspect.

Preferably the at least one computer program is embodied on a recording medium or read-only memory, stored in at least one computer memory, or carried on an electrical carrier signal.

The present invention will now be described by way of example only with reference to the accompanying figures in which;

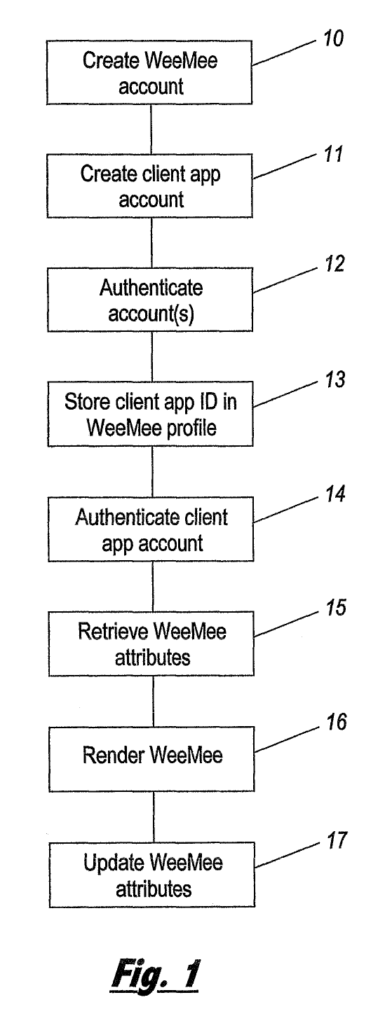

FIG. 1 illustrates in a flowchart of the steps according to a preferred embodiment of the present invention;

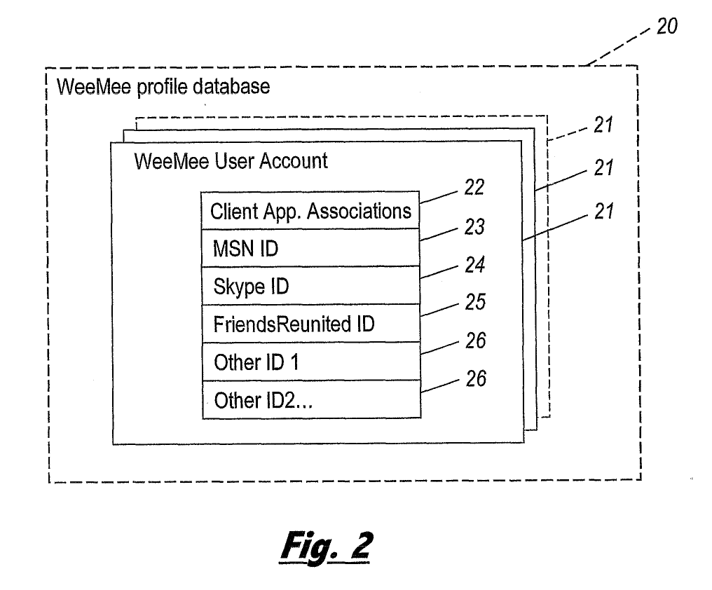

FIG. 2 illustrates in schematic form a client application account associations table;

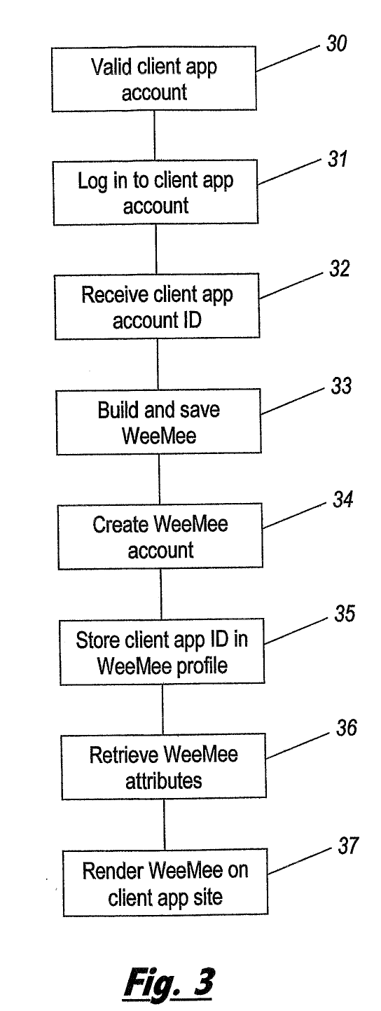

FIG. 3 illustrates a flowchart of the steps according to a second embodiment of the present invention;

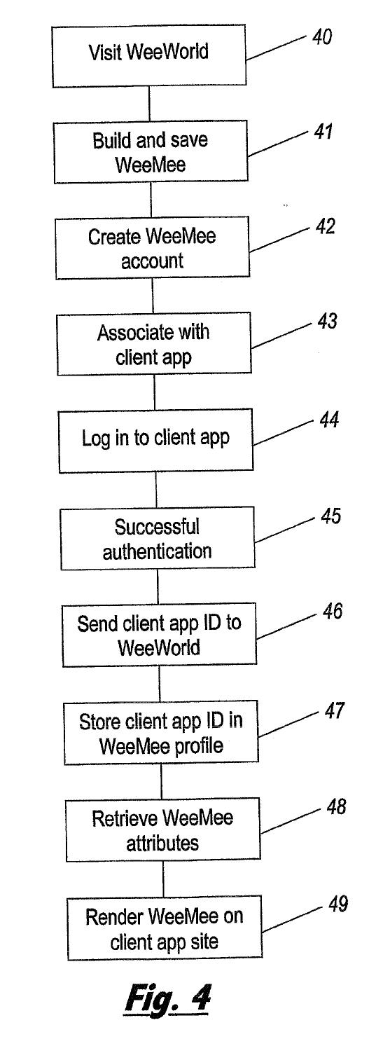

FIG. 4 illustrates a flowchart of the steps according to a third embodiment of the present invention;

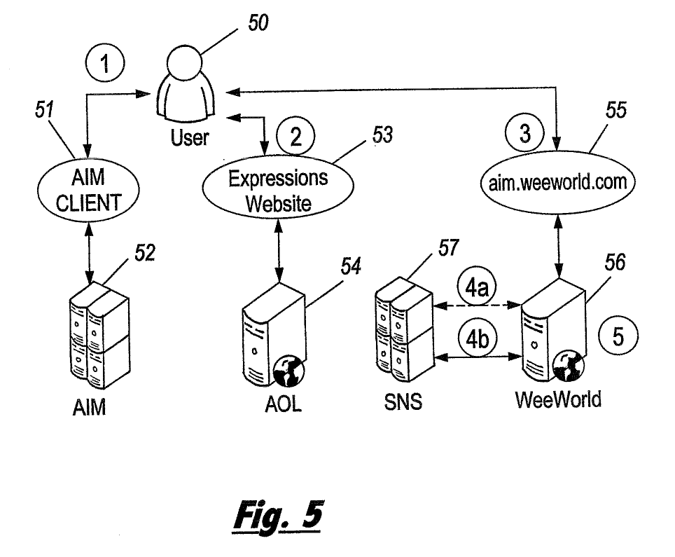

FIG. 5 illustrates in schematic form partial user registration with WeeWorld;

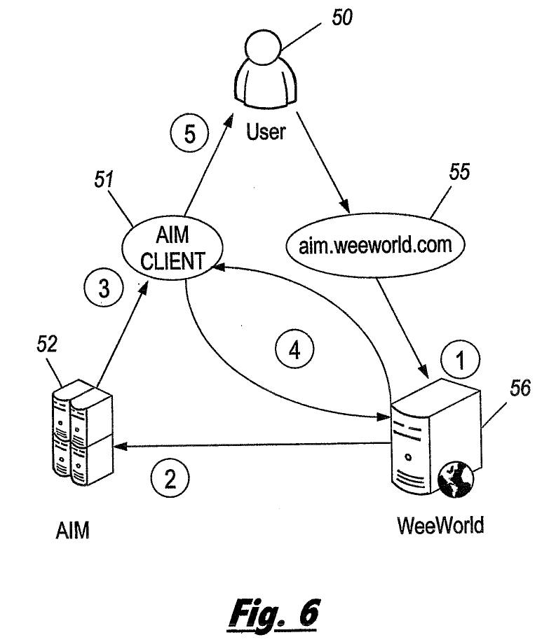

FIG. 6 illustrates in schematic form installation of the WeeMee expression from a micro site;

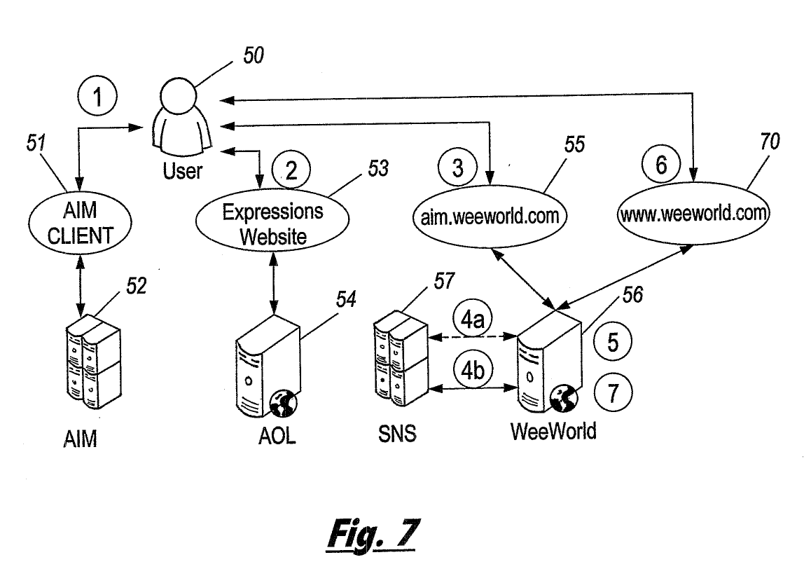

FIG. 7 illustrates in schematic form full user registration with WeeWorld;

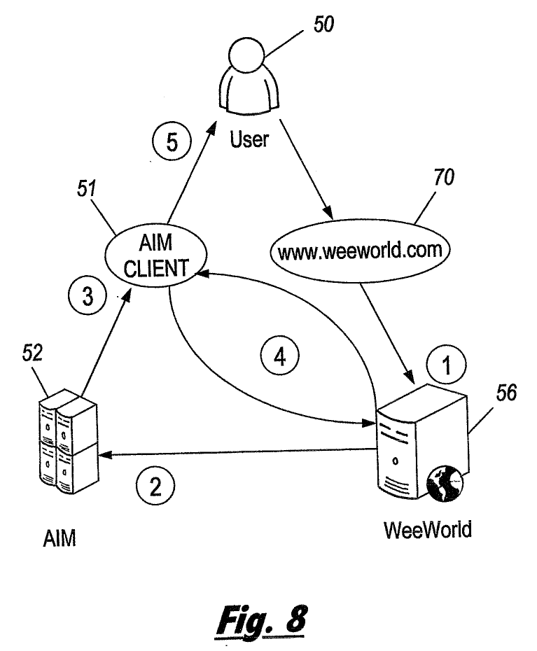

FIG. 8 illustrates in schematic form installation of the WeeMee expression from WeeWorld;

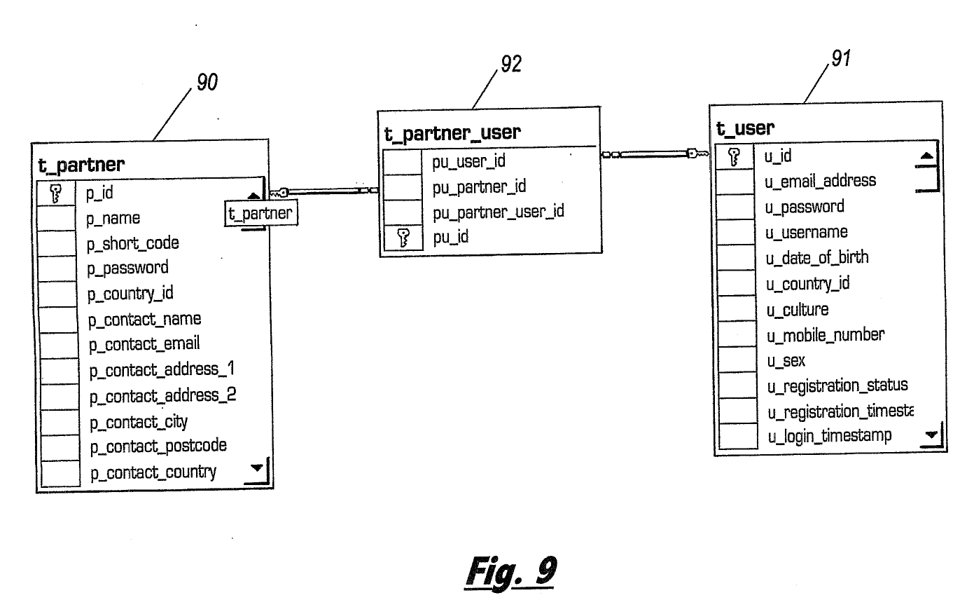

FIG. 9 illustrates the WeeWorld partner registration schema;

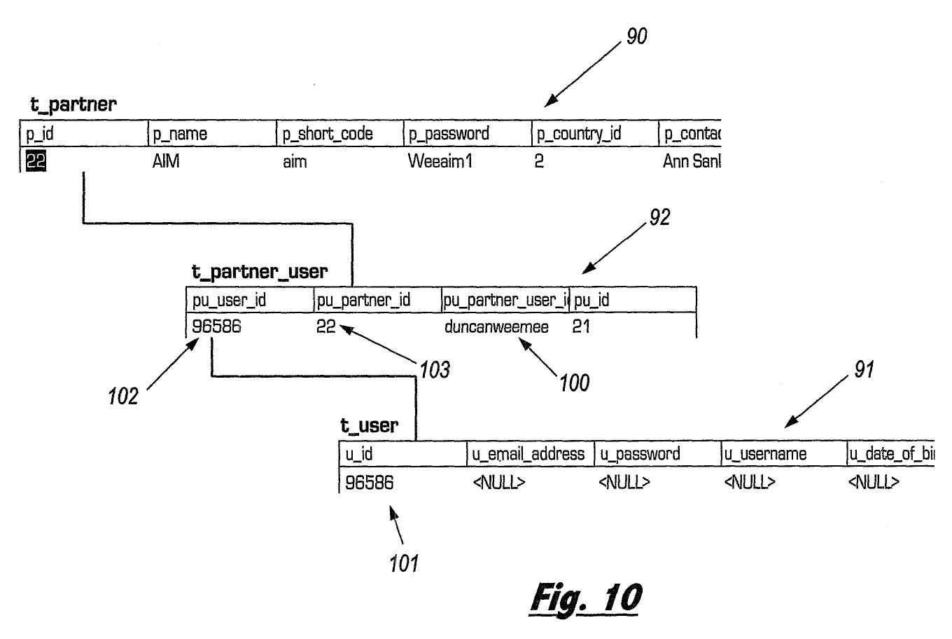

FIG. 10 illustrates the data view of partial registration; and

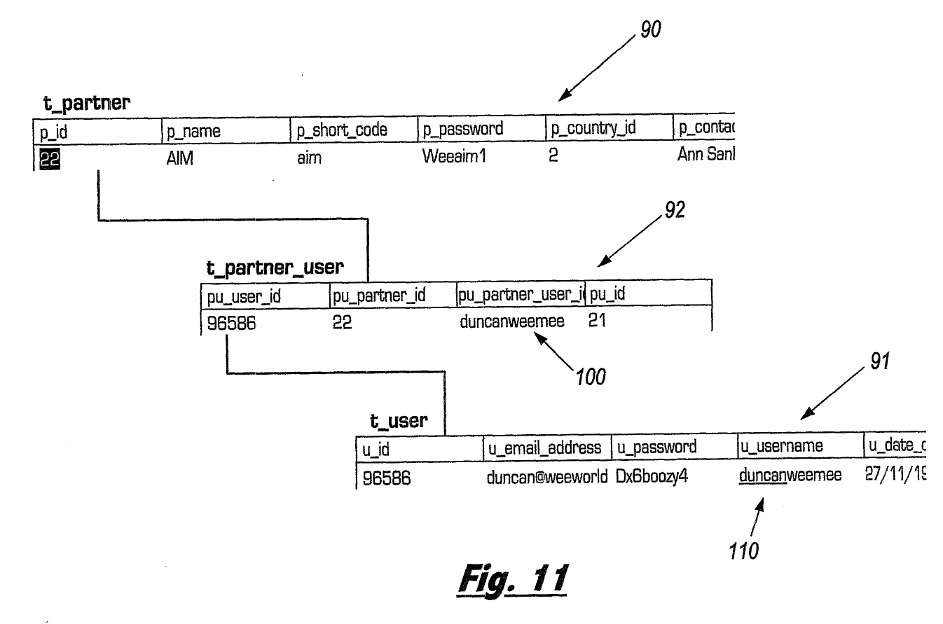

FIG. 11 illustrates the data view of complete registration.

The preferred embodiment of the present invention relates to avatars called WeeMees and the ability for a user's WeeMee to be used with a variety of partner client application is (e.g., MSN Messenger®, Skype®, Friends Reunited® etc). This means that rather than have a different WeeMee for each application the invention allows the user to have a single WeeMee account which they can associate with each of the client applications that they use.

FIG. 1 shows the steps of a method according to a preferred embodiment of the present invention.

The first step is to create a WeeMee user account 10. The user builds and saves their WeeMee. The WeeMee account has a WeeMee account identifier and WeeMee account information that includes the attributes or assets that capture a users preferences and are used to render the WeeMee in a client application. These applications can be Web applications or applications on mobile devices or any other application that has the ability to use the WeeMee account information, for example to render an avatar and assets associated with it, such as backgrounds and objects that the user has associated with their avatar and multimedia content that the user has associated with the objects.

Next, the user creates a client application user account 11 that has a client application account identifier. After authenticating either or both accounts 12, the client application account identifier is associated with the WeeMee account by storing 13 the client application account identifier in the WeeMee account profile.

Subsequently, when the user logs into a client application by authenticating the client application account identifier 14, the client application can retrieve the WeeMee account information, which in this embodiment are avatar attributes, using the client application account identifier. This is possible because the client application account identifier is associated with the WeeMee user account such that the information of the WeeMee user account information can be retrieved by looking up the client application identifier stored in the database of WeeMee profiles.

The client application renders 16 the WeeMee avatar and assets using the retrieved WeeMee account information. The WeeMee account information that is retrieved may depend on the particular client application that has been used, or based on a user preference or user input. For example, the user may have a business WeeMee or a leisure WeeMee that they can select for display or that is automatically selected for them by the client application in co-operation with the WeeMee account. Finally, the user can update the WeeMee 17 from within the client application such that the attributes of the WeeMee account information are updated again using the client application account identifier to access the WeeMee account information.

FIG. 2 shows a database that stores the WeeMee user account profiles 21. The profiles contain associated with the WeeMee account client application identifiers 22, in this example, an MSN ID 23, a Skype ID 24 and a Friends Reunited ID 25, in addition to other account ID's 26.

This embodiment of the present invention provides management of the association between the user's WeeMee account and the various client applications. In addition to management of this association, implementation of the present invention also handles the diverse login and authentication needs of WeeMee accounts and the various supported client applications.

With reference to FIG. 3, a further embodiment of part of the present invention is shown. The user is provided with a valid client application account 30 (e.g., MSN) and arrives at a virtual world application, called WeeWorld, accessed via logging on to client account 31 directly from the client applications website. The user will have been logged in and authenticated by the client application site. The client application site passes the client application account identifier for the user to the WeeMee application 32. The user then builds and saves their WeeMee 33 and creates a WeeMee account 34, then that client application account identifier is saved 35 in an association table at the heart of the users WeeMee account profile, as shown in FIG. 2. The client application can then retrieve WeeMee attributes 36 and use them to render 37 the WeeMee on the client application site.

With reference to FIG. 4, an alternative embodiment of part of the present invention is shown. In this case the user visits WeeWorld directly 40. The user builds and saves a WeeMee 41 then creates a WeeMee account 42. The user then has ah opportunity within WeeWorld to make an association between their WeeMee account and the supported partners who offer client applications 43. On choosing a partner, the user is requested to log in to the partner's client Application 44. This process can be done by either WeeWorld collecting a partner log in identity and password and sending these to a partner site, or alternatively, WeeWorld initiating a log-in session directly on the partner's client application site where the user's client application identifier and password are entered and authenticated directly by the client application. In both cases, successful authentication 45 results in the client application identifier for that user being passed back 46 to WeeWorld. As with the embodiment of FIG. 3, the client account identifier is saved in an association table 47 as part of the user's WeeMee account profile. The client application can then retrieve WeeMee attributes 48 and use them to render 49 the WeeMee on the client application site.

Each WeeMee account user can have many associated client applications which may be created via the processes describes with reference to FIGS. 3 and 4. Having set up the client application associations from WeeWorld, a user who returns to WeeWorld from one of the client applications (accompanied by the same client application account identifier) will be taken automatically to the correct WeeMee account.

In a further embodiment, the flow of data between the applications and services of AOL (America On Line) and WeeWorld during the creation of a WeeMee expression is described below. It also shows how user specific SNS (Screen Name Services) data is handled and stored on WeeWorld servers to allow secure handover of users between the SNS and WeeWorld namespaces.

In a partial WeeWorld registration scenario, the user moves from the Triton AIM (AOL Instant Messenger) client to the WeeWorld micro site where they create and save their WeeMee. In order to store the user's WeeMee profile, we create a partial registration in the WeeWorld namespace. The difference between a partial and full registration is illustrated in the description relating to FIGS. 9 to 11 below.

In FIGS. 5 to 8, arrows with arrow heads represent the interaction between entities in the application. All interaction takes place through the exchange of data over HTTP/HTTPS channels. The numbers in circles label the steps described below.

With reference to FIG. 5:
1. User 50 logs in to AIM using the AIM Triton client 51 to connect to the AIM servers 52.
2. User 50 moves to AIM expressions site 53 hosted by the AOL server 54 via menu link in the Triton client 51.
3. User selects WeeMee option from Expressions site 53 menu taking the user to the WeeWorld micro site 55.
4. WeeWorld server 56 performs SNS authentication of user using the SNS servers 57.
a. User is SNS authenticated. Jump to step 5.
b. User is not SNS authenticated, prompt user to sign in. Repeat until user is authenticated.
5. Partial registration of user, including building and saving a WeeMee, is performed in WeeWorld namespace at the WeeWorld server 56 using the unique identifier from SNS credentials.

Once the user has passed through each phase of the application, they are ready to install their WeeMee expression in the AIM Triton client.

FIG. 6 shows an outline of the data flow during installation from the WeeWorld micro site.
1. User 50 requests download/installation of WeeMee from micro site 55.
2. WeeWorld servers 56 call web service on AIM server 52 to indicate that a new expression is available for SNS authenticated user. The web service call will supply AIM servers 52 with a unique identifier for newly created expression and URL locating expression resources on WeeWorld servers 56.
3. AIM servers 52 alert users' AIM client 51 that expression is available for download.
4. AIM client 51 downloads expression resources from WeeWorld URL 56.
5. User 50 interacts while using the WeeMee expression.

With reference to FIG. 7, in a full WeeWorld registration scenario, the user moves from the Triton AIM client to the WeeWorld micro site as in the partial WeeWorld registration scenario discussed in relation to FIGS. 5 and 6. The difference in this case is that the user elects to register with weeworld.com 70 and visit the site to browse for other WeeMee items that are unavailable on the AIM WeeMee micro site.

All steps preceding the full registration with WeeWorld are executed exactly as in the partial WeeWorld registration scenario.
1. User 50 logs in to AIM using the AIM Triton client 51 to connect to the AIM servers 52.
2. User moves to AIM expressions site 53 via menu link in the Triton client 51.
3. User selects WeeMee option from Expressions site 53 menu taking the user to the WeeWorld micro site 55.
4. WeeWorld servers 56 perform SNS authentication of the user 50 using the SNS servers 57.
   a. User is SNS authenticated. Jump to step 5.
   b. User is not SNS authenticated, prompt user to sign in. Repeat until user is authenticated.
5. Partial registration of user is performed in WeeWorld namespace at the WeeWorld server 56 using the screen name from the SNS credentials.
6. User elects to register with WeeWorld. Browser redirects to www.weeworld.com 70.
7. User completes and submits WeeWorld registration form. Full registration of user in the WeeWorld namespace executed at the WeeWorld server 56. Authentication handover from SNS to WeeWorld.

Once the user has moved through all seven phases, they can then begin to browse the catalogue of available WeeMee items on WeeWorld. Once they have made their selections and purchased a pack of WeeMee, items using the WeeWorld billing system, they are given the option to download/install the WeeMee expression in to their AIM client. FIG. 8 shows that the flow of data in this installation process is exactly the same as in scenario 1, except the user requests download/installation of the WeeMee from the, main WeeWorld site 70 rather than the micro site 55.

With reference to FIGS. 9 to 11, in order to persistently store the WeeMee profile of an AIM user, a unique identifier is required. As the WeeWorld micro site is SNS authenticated, the present invention can use the AIM user's screen name as the unique identifier within the WeeWorld database. However, since one cannot guarantee the uniqueness of the AIM user's screen name within the WeeWorld database, the present invention does not simply create a new user account with the WeeWorld username set to be the same value as the AIM user's screen name. Instead, the present invention creates a partial registration for the AIM user where the screen name is used as an index to store and lookup a partially complete WeeWorld user account with a null value for the WeeWorld username. This is sufficient to allow us to store and lookup the AIM user's WeeMee profile from the WeeWorld micro site and therefore manage the installation of an AIM expression.

If the user opts to browse WeeWorld.com for additional WeeMee items, the present invention prompts them to provide enough details to perform a complete WeeWorld registration. At thus stage, the present invention perform a lookup of WeeWorld accounts to determine if the AIM user's screen name is available within the WeeWorld namespace. If the screen name is available within WeeWorld then the same value can be used as the unique identifier in both namespaces. If the screen name is not available in the WeeWorld namespace, the present invention can suggest some simple alternatives or the user may choose a completely different value for their WeeWorld username. Indeed, even if the screen name is available within the WeeWorld namespace, the user may wish to use a different value and the present invention allows them to do so.

To support this functionality, the present invention uses the database schema shown in FIG. 9. In this schema, the t_partner table 90 contains rows describing a WeeWorld partner organization. For the purposes of integration with AIM, this will contain basic contact information for AOL.

The t_user table 91 is the table the present invention uses to manage registrations within the WeeWorld namespace. The columns in this table allow us to store standard registration information for our users and the u_username field is used to store the WeeWorld username.

The t_partner_user association table 92 is effectively an index table which allows us to lookup rows in the t_user table based on a partner ID value (the pu_partner_id field) and a value which uniquely identifies a user within the partner's namespace (the pu_partner_user_id field).

FIG. 10 shows some sample data entered in to each of these tables after the completion of a partial registration of an AIM user with screen name ‘duncanweemee’ 100. It should be noted that all the fields in the t_user table have a null value except the u_id field 101.

The WeeMee profile for ‘duncanweemee’ is stored against this id value 102 and the present invention can perform a lookup of the WeeMee profile from the WeeWorld micro site when the user is SNS authenticated because it is looking for the profile of a user who has pu_id=22 103 and pu_partner_user_id=‘duncanweemee’ 100 in the t_partner_user table 92.

FIG. 11 shows sample data for the same user once they have opted to register with WeeWorld and visit the main WeeWorld.com website. Here, the t_user table 91 fields contain values instead of nulls.

In this case, ‘duncanweemee’ 110 must have been available within WeeWorld otherwise it could not have been used as the WeeWorld username. If the screen name already existed in the t_user table 91 the u_username field 110 would have to contain a different value than the pu_partner_user_id value 100 in the t_partner_user table 92.

Further modifications and improvements may be added without departing from the scope of the invention described by the claims.

1. A method of retrieving user account information comprising the steps of:
providing a first user account having a first account identifier and first account information;
providing a second user account having a second account identifier;
associating the second account identifier with the first user account; and
retrieving the first account information using the associated second account identifier.

2. The method of claim 1, wherein the step of providing a second user account is performed prior to the step of providing a first user account.

3. The method of claim 1, further comprising the step of authenticating the second account identifier prior to the step of retrieving the first account information.

4. The method of claim 1, further comprising the step of authenticating, the first user account prior to tie step of associating the second account with the first user account.

5. The method of claim 1, further comprising the step of authenticating the second user account prior to the step of associating the second account identifier with the first user account.

6. The method of claim 1, wherein the step of providing a first user account comprises the steps of:
providing access to a first user account application;
receiving the first account information into the first user account application; and
creating the first user account.

7. The method of claim 6, wherein the access to the first user account application is provided, subsequent to authenticating the second user account, directly from a second user account application.

8. The method of claim 7, wherein the step of authenticating the second user account comprises the steps of logging in to the second user account application and passing the second account identifier to the first user account application.

9. The method of claim 6, wherein the step of creating the first user account comprises building an avatar and saving the avatar profile.

10. The method of claim 1, wherein the step of associating comprises storing the second account identifier, in an association table.

11. The method of claim 1, wherein the step of associating comprises storing the second account identifier in an account profile of the first user account.

12. The method of claim 8, wherein the step of associating comprises a user choosing a second account provider prior to the step of logging in to the second user account application.

13. The method of claim 1, wherein the first account information comprises personal information relating to a user.

14. The method of claim 1, wherein the first account information comprises attributes of the user.

15. The method of claim 1, wherein the first account information comprises historical account information.

16. The method of claim 15, wherein the historical account information comprises a history of changes.

17. The method of claim 1, further comprising the step of rendering an avatar using the first account information.

18. The method of claim 17, further comprising the step of rendering an asset associated with the avatar using the first account information.

19. The method of claim 18, wherein the asset comprises a background.

20. The method of claim 18, wherein the asset comprises an object.

21. The method of any of claim 17, wherein the step of rendering is performed by an application the use of which has been authenticated by the step of authenticating the second account identifier.

22. The method of claim 17, further comprising the steps of: the first user account application passing to the second user account application a link to resources for rendering the avatar; and the second user account application rendering the avatar using the linked resources.

23. At least one computer program comprising program instructions for causing at least one computer to perform the method according to claim 1.

24. The at least one computer program of claim 23 embodied on a recording medium or read-only memory, stored in at least one computer memory, or carried on an electrical carrier signal.
